(19) United States
(12) Patent Application Publication
(10) Pub. No.: US 2015/0339660 A1
(43) Pub. Date: Nov. 26, 2015

(54) METHOD AND SYSTEM FOR OFF-LINE CREDIT FOR LOAD

(71) Applicant: China Unionpay Co., Ltd., Shanghai (CN)

(72) Inventors: Hongwen Meng, Shanghai (CN); Gaofeng Wan, Shanghai (CN); Jianbin Zheng, Shanghai (CN)

(73) Assignee: CHINA UNIONPAY CO., LTD., Shanghai (CN)

(21) Appl. No.: 14/402,682

(22) PCT Filed: Jun. 6, 2013
(86) PCT No.: PCT/CN2013/076857

§ 371 Date: Nov. 20, 2014

(30) Foreign Application Priority Data
Jun. 6, 2012 (CN) 201210183592.6

(51) Int. Cl. G06Q 20/34; G06Q 20/40; G06Q 20/06; G06Q 20/10

(52) U.S. Cl. CPC G06Q 20/349; G06Q 20/108; G06Q 20/409; G06Q 20/065

(57) ABSTRACT

The invention discloses an offline credit loading method and system. The offline credit loading method comprises the following steps: (A) a terminal performs update of credit loading limit of a terminal by communicating with a backstage system, wherein the credit loading limit of the terminal is a sum of capital that allows for offline credit loading; (B) an electronic card performs update of the account of electronic cash card by communicating with the terminal, wherein some capital of the credit loading limit of the terminal is transferred to the account of electronic cash card; and (C) the backstage system enables the credit loading account associated with the account of electronic cash card to be updated according to information on offline credit loading received from the terminal.

### PRIORITY

The application claims priority from Chinese patent application No. 201210183592.6, entitled “Offline Credit Loading Method and System”, filed on Jun. 6, 2012, the content of which is incorporated herein in its entirety by reference.

### FIELD OF THE INVENTION

The invention relates to electronic cash, and in particular, to an offline crediting method and system adapted for electronic cash.

### BACKGROUND

An electronic cash card is stored therein with legitimate cash balance which can be used for offline consumption, thus meeting requirements of the applications of some industries (e.g., bus, taxi, railway, subway, etc.). When there is not enough amount (or limit) in the account of electronic cash card (referred to as “cash card” for short), the card needs to be recharged.

One way of recharging is credit loading, which is a process of deducting some capital from the account (i.e., crediting load account, which can be a credit card, a debit card associated with the cash card, etc.) of card owner and storing the deducted amount (or limit) into the cash card. However, credit loading in the prior art has to be performed online. That is, when the cash card is being recharged at a recharge terminal, the recharge terminal must communicate with the issuing bank of the credit card, debit card which is used as the credit loading account and is associated with the cash card so as to verify authenticity of the cash card and card owner, thus completing credit loading. Online credit loading completes recharging the cash card according to recharge script returned from the issuing bank, and realize a synchronization of capital between electronic cash account of card owner and credit loading account in real time.

### SUMMARY OF THE INVENTION

According to an object of the invention, an offline credit loading method is disclosed, comprising the following steps:

(A) a terminal performs update of credit loading limit of a terminal by communicating with a backstage system, wherein the credit loading limit of the terminal is a sum of capital that allows for offline credit loading;

(B) an electronic card performs update of the account of electronic cash card by communicating with the terminal, wherein some capital of the credit loading limit of the terminal is transferred to the account of electronic cash card; and

(C) the backstage system enables the credit loading account associated with the account of electronic cash card to be updated according to information on offline credit loading received from the terminal.

Preferably, at step (A), the terminal sends an update request of credit loading limit of the terminal to the backstage system, which request comprises ID of a safety module provided in the terminal, wherein the safety module is used for storing the credit loading limit of the terminal, the backstage system generates an update command of the credit loading limit of the terminal according to the update request of credit loading limit of the terminal, which command is received by the terminal, and the terminal updates the credit loading limit of the terminal stored in the safety module according to the update command of the credit loading limit of the terminal.

Preferably, at step (B):

(a) the electronic cash card sends a request of offline credit loading to the terminal;

(b) the terminal verifies the electronic cash card according to the request of offline credit loading;

(c) the terminal returns a confirmation response to the offline credit loading to the electronic cash card;

(d) the electronic cash card verifies the terminal according to the confirmation response to the offline credit loading;

(e) the terminal sends a command of offline credit loading to the electronic cash card;

(f) the electronic cash card updates the account of electronic cash card according to the command of offline credit loading.

Preferably, at step (a), when the balance of the account of electronic cash card is lower than a predetermined value, the electronic cash card sends the request of offline credit loading to the terminal.

According to another object of the invention, an offline credit loading system is disclosed which comprises an electronic cash card, a terminal and backstage system, wherein the terminal is configured to perform update of credit loading limit of a terminal by communicating with the backstage system, the terminal credit loading limit is a sum of capital that allows for offline credit loading, the electronic cash card is configured to perform update of the account of electronic cash card by communicating with the terminal, some capital of the credit loading limit of the terminal is transferred to the account of electronic cash card, and wherein the backstage system is configured to enable the credit loading account associated with the account of electronic cash card to be updated according to information on offline credit loading received from the terminal.

Preferably, the terminal is configured to send an update request of credit loading limit of the terminal to the backstage system, which request comprises ID of a safety module provided in the terminal, wherein the safety module is used for storing the credit loading limit of the terminal, the backstage system is configured to generate an update command of the credit loading limit of the terminal according to the update request of credit loading limit of the terminal, and the terminal is configured to receive the update command of credit loading limit of the terminal and update the credit loading limit of the terminal stored in the safety module according to the update command of the credit loading limit of the terminal.

Preferably, the electronic cash card is configured to send a request of offline credit loading to the terminal, the terminal is configured to verify the electronic cash card according to the request of offline credit loading, the terminal is configured to return a confirmation response to the offline credit loading to the electronic cash card, the electronic cash card is configured to verify the terminal according to the confirmation response to the offline credit loading, the terminal is configured to send a command of offline credit loading to the electronic cash card, and the electronic cash card is configured to update the account of electronic cash card according to the command of offline credit loading.

Preferably, the electronic cash card is configured such that when the balance of the account of electronic cash card is lower than a predetermined value, the electronic cash card sends the request of offline credit loading to the terminal.

Preferably, the backstage system stores a master key for limit update, and the safety module stores a sub key for limit update, wherein the backstage system calculates the sub key for limit update using the master key for limit update and based on the ID of the safety module, and encrypts the update command of the credit loading limit of the terminal using the calculated the sub key for limit update, and the terminal decrypts the update command of the credit loading limit of the terminal using the sub key for limit update.

Preferably, the safety module also stores a master key for offline credit loading, and the electronic cash card stores a sub key for offline credit loading, wherein the request of offline credit loading comprises a first authentication code of offline credit loading which is generated by the electronic cash card based on the sub key for offline credit loading and a first category of transaction data; and the safety module is further configured to calculate the sub key for offline credit loading according to the ID of the electronic cash card and the master key for offline credit loading, and to use the calculated sub key for offline credit loading and the first category of transaction data to generate a second authentication code of offline credit loading; and when the second authentication code of offline credit loading is the same as the first authentication code of offline credit loading, the safety module determines that the electronic cash card has passed the authentication.

Preferably, the confirmation response to the offline credit loading comprises a first confirmation code of offline credit loading which is generated by the safety module based on the calculated sub key for offline credit loading and a second category of transaction data, and the electronic cash card is further configured to calculate a second confirmation code of offline credit loading based on the sub key for offline credit loading and the second category of transaction data; and when the second confirmation code of offline credit loading is the same as the first confirmation code of offline credit loading, the electronic cash card determines that the terminal has passed the authentication.

According to another object of the invention, an electronic cash card is disclosed which is configured to be able to send a request of offline credit loading to a terminal, to verify the terminal according to a confirmation response to the offline credit loading returned from the terminal, to receive a command of offline credit loading from the terminal, and to update the account of the electronic cash card according to the command of offline credit loading.

Preferably, the electronic cash card stores a minimum predetermined value of balance, and the electronic cash card is configured such that when the balance of the account of electronic cash card is lower than the minimum predetermined value of balance, the electronic cash card sends the request of offline credit loading to the terminal.

According to another object of the invention, an offline credit loading terminal is disclosed which comprises a safety module used for storing credit loading limit of the terminal, wherein the terminal is configured to be able to send an update request of credit loading limit of the terminal to a backstage system, the update request of credit loading limit of the terminal comprises ID of the safety module, the terminal is further configured to receive an update command of the credit loading limit of the terminal, and to update the credit loading limit of the terminal stored in the safety module according to the update command of the credit loading limit of the terminal.

Preferably, the terminal is further configured to be able to receive a request of offline credit loading from the electronic cash card, to verify the electronic cash card according to the request of offline credit loading, and to send a command of offline credit loading to the electronic cash card, which command is used for updating the account of the electronic cash card.

### BRIEF DESCRIPTION OF THE DRAWINGS

Various aspects of the invention will be more clearly understood by those skilled in the art after reading the particular embodiments of the invention with reference to the accompanying drawings. It is understood by those skilled in the art that the drawings are merely used for explaining the technical solutions of the invention in conjunction with the particular embodiments, rather than limiting the scope of protection of the invention.

FIG. 1 is a schematic view of an offline credit loading system according to an embodiment of the invention.

FIG. 2 is a flowchart view of an offline credit loading method according to an embodiment of the invention.

FIG. 3 is a schematic view showing information interaction in the offline credit loading method according to an embodiment of the invention.

FIG. 4 is a schematic view showing information interaction in the offline credit loading method according to an embodiment of the invention.

FIG. 5 is a schematic view showing information interaction in the offline credit loading method according to an embodiment of the invention.

### DETAILED DESCRIPTION OF THE INVENTION

The particular embodiments of the invention will be further described in detail hereinafter with reference to the accompanying drawings.

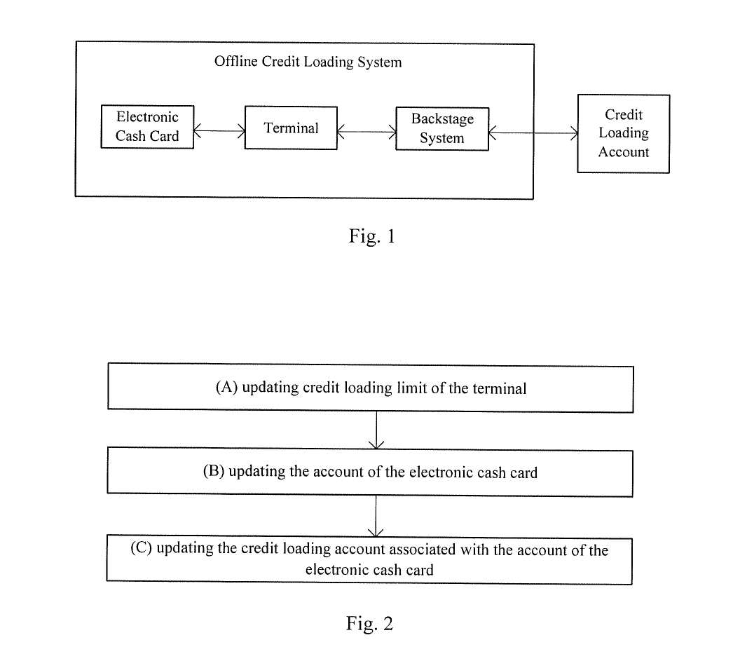

FIG. 1 is a schematic view of an offline credit loading system according to an embodiment of the invention. As shown in the figure, the system comprises an electronic cash card, a terminal and a backstage system. The terminal is configured to perform update of credit loading limit of the terminal by communicating with the backstage system. Here, the credit loading limit of the terminal is a sum of capital that allows for offline credit loading. The electronic cash card is configured to perform update of the account of electronic cash card by communicating with the terminal, wherein some capital of the credit loading limit of the terminal is transferred to the account of electronic cash card. Here, the electronic cash card for offline credit loading is associated in advance with the credit loading account in the backstage system. According to the embodiment of the invention, the electronic cash card can perform credit loading by merely communicating with the terminal without need for online processing with the issuing bank of the credit loading account, which will be described with more details later. The backstage system is configured to enable the credit loading account that is associated with the account of the electronic cash card to be updated according to information on offline credit loading received form the terminal.

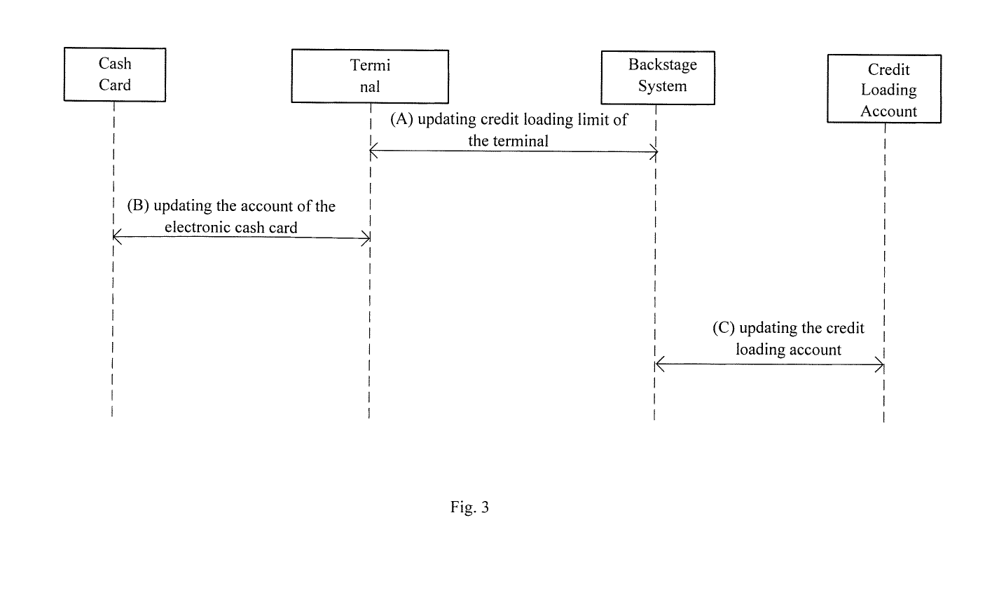

FIG. 2 is a flowchart view of an offline credit loading method according to an embodiment of the invention. The offline credit loading method according to the embodiment of the invention will be described herein with reference to the schematic views of information interaction shown in FIGS. 3 to 5. As shown in FIGS. 2 and 3, at step (A), the terminal updates the credit loading limit of the terminal by communicating with the backstage system; at step (B), the electronic card updates the account of electronic cash card by communicating with the terminal; at step (C), the backstage system enables the credit loading account associated with the account of electronic cash card to be updated according to information on offline credit loading received from the terminal. It can be understood that the step (A) herein is optional since when the credit loading limit of the terminal is not enough to recharge the recharge limit requested by the electronic cash card, the terminal will request for an update of the credit loading limit of the terminal; alternatively, the terminal can also request for an update of the credit loading limit of the terminal on its own initiative at any time, e.g., after the last time when the account of the electronic cash card was updated, or after the credit loading account was updated.

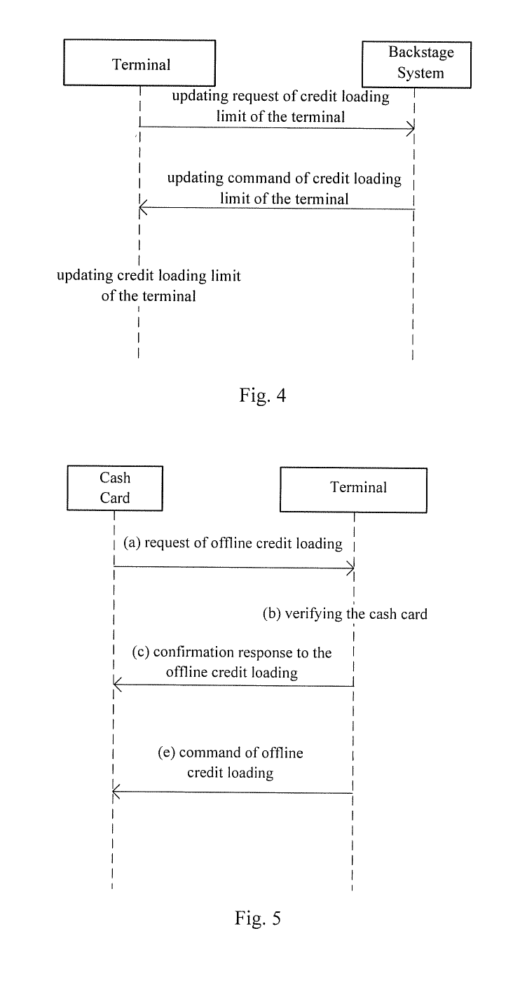

FIG. 4 is a schematic view showing information interaction in the offline credit loading method according to an embodiment of the invention. FIG. 4 schematically shows information interaction between the terminal and the backstage system at step (A), wherein firstly, the terminal sends an update request of the credit loading limit of the terminal to the backstage system, the update request comprises ID of the safety module provided in the terminal, and wherein, the safety module is used for storing the credit loading limit of the terminal. Then, the backstage system generates an update command of the credit loading limit of the terminal according to the update request of the credit loading limit of the terminal. Then, the terminal receives the update command of the credit loading limit of the terminal, and updates the credit loading limit of the terminal stored in the safety module according to the update command of the credit loading limit of the terminal. In one example, the backstage system stores a master key for limit update, and the safety module stores a sub key for limit update, wherein the backstage system calculates the sub key for limit update using the master key for limit update and based on the ID of the safety module, and encrypts the update command of the credit loading limit of the terminal using the calculated the sub key for limit update, and the terminal decrypts the update command of the credit loading limit of the terminal using the sub key for limit update. For example, the backstage system can calculate the sub key for limit update according to the terminal ID (TID), merchant ID (MID) and safety module ID using a predetermined algorithm.

FIG. 5 is a schematic view showing information interaction in the offline credit loading method according to an embodiment of the invention. FIG. 5 schematically shows information interaction between the electronic cash card and the terminal at step (B). At step (a), the electronic cash card sends a request of offline credit loading to the terminal. At step (b), the terminal verifies the electronic cash card according to the request of offline credit loading. At step (c), the terminal returns a confirmation response to the offline credit loading to the electronic cash card. At step (d), the electronic cash card verifies the terminal according to the confirmation response to the offline credit loading. At step (e), the terminal sends a command of offline credit loading to the electronic cash card. At step (f), the electronic cash card updates the account of the electronic cash card according to the command of offline credit loading.

In one example, the safety module also stores a master key for offline credit loading, and the electronic cash card stores a sub key for offline credit loading, wherein the request of offline credit loading comprises a first authentication code of offline credit loading which is generated by the electronic cash card based on the sub key for offline credit loading and a first category of transaction data; and the safety module is further configured to calculate the sub key for offline credit loading according to the ID of the electronic cash card and the master key for offline credit loading, and to use the calculated sub key for offline credit loading and the first category of transaction data to generate a second authentication code of offline credit loading; and when the second authentication code of offline credit loading is the same as the first authentication code of offline credit loading, the safety module determines that the electronic cash card has passed the authentication.

For example, the cash card can calculate a process key of the sub key for offline credit loading, and organizes transaction elements as the data generating the first authentication code of offline credit loading, i.e., the first category of transaction data. The transaction elements can comprise counts of offline credit loading. Here, the cash card can store a counter for offline credit loading to calculate the counts of offline credit loading. Then, the cash card can use the process key and the above organized data to generate the first authentication code of offline credit loading according to a predetermined algorithm. On the other hand, the terminal verifies the first authentication code of offline credit loading from the cash card. The terminal can calculate the sub key for offline credit loading corresponding to the current cash card according to the ID of the cash card, and then calculate the process key of the cash card according to the calculated sub key for offline credit loading. The terminal re-calculates the second authentication code of offline credit loading of the cash card by using the process key and the first category of transaction data. The terminal verifies the cash card by comparing the first authentication code of offline credit loading of the cash card with the second authentication code of offline credit loading of the cash card to see if they are the same. Those skilled in the art will understand that other ways of verifying the electronic cash card can also be used.

In another example, the confirmation response to offline credit loading comprises a first confirmation code of offline credit loading which is generated by the safety module based on the calculated sub key for offline credit loading and a second category of transaction data, and the electronic cash card is further configured to calculate a second confirmation code of offline credit loading based on the sub key for offline credit loading and the second category of transaction data; and when the second confirmation code of offline credit loading is the same as the first confirmation code of offline credit loading, the electronic cash card determines that the terminal has passed the authentication.

For example, the terminal calculates the first confirmation code of offline credit loading by using the process key of the cash card calculated according to the calculated sub key for offline credit loading and a second category of transaction data (e.g., the amount of offline credit loading, the date of transaction, etc.) that is different from the first category of transaction data according to a predetermined algorithm. On the other hand, the cash card organizes the second category of transaction data, and uses the process key corresponding to the sub key of offline credit loading and the second category of transaction data to calculate the second confirmation code of offline credit loading, and verifies the terminal by comparing the first confirmation code of offline credit loading with the second confirmation code of offline credit loading to see if they are the same. Those skilled in the art will understand that other ways of verifying the terminal can also be used.

In the above embodiment, the safety module provided in the terminal can be a SAM card. The sub key for limit update distributed by the backstage system and the sub key for offline credit loading can be stored in the SAM card. Therefore, the SAM card completes authentication of the cash card.

In one embodiment, at step (C), the backstage system enables the credit loading account associated with the account of electronic cash card to be updated according to information on offline credit loading received from the terminal. Here, the information on offline credit loading may comprise details of offline credit loading, authentication code of transaction or authentication code of issuing bank, wherein the authentication code of transaction or the authentication code of issuing bank are calculated by the cash card, the authentication code of transaction is used for the backstage system to make the confirmation and the authentication code of issuing bank is used for the backstage system to make the confirmation. The terminal can send information on offline credit loading at designated time by the backstage system, and the backstage system can use the information on offline credit loading to communicate with the issuing bank so as to enable the credit loading account associated with the account of electronic cash card to be updated. The backstage system can transfer amount of credit loading to a merchant account associated with the terminal from the credit loading account associated with the account of electronic cash card at an appropriate time.

According to an embodiment of the invention, an electronic cash card is disclosed which is configured to be able to send the request of offline credit loading to the terminal, to verify the terminal according to the confirmation response to the offline credit loading returned from the terminal, to receive the command of offline credit loading from the terminal, and to update the account of the electronic cash card according to the command of offline credit loading. In one example, the electronic cash card stores a predetermined value, and the electronic cash card is configured such that when the balance of the account of electronic cash card is lower than the predetermined value, the electronic cash card sends the request of offline credit loading to the terminal.

According to an embodiment of the invention, an offline credit loading terminal is disclosed which comprises a safety module used for storing credit loading limit of the terminal, wherein the terminal is configured to be able to send the update request of credit loading limit of the terminal to the backstage system, the update request of credit loading limit of the terminal comprises ID of the safety module, the terminal is further configured to receive the update command of the credit loading limit of the terminal, and to update the credit loading limit of the terminal stored in the safety module according to the update command of the credit loading limit of the terminal. In one example, the terminal is further configured to be able to receive the request of offline credit loading from the electronic cash card, to verify the electronic cash card according to the request of offline credit loading, and to send the command of offline credit loading to the electronic cash card, which command is used for updating the account of the electronic cash card.

Through description of the above embodiments, those with ordinary skills in the art will understand that various variations and replacements can also be made to the particular embodiments of the invention without departing from the spirit and scope of the invention. These variations and replacements all fall within the scope defined by the claims of the invention.

1. An offline credit loading method characterized by comprising the following steps:
(A) a terminal performs update of credit loading limit of a terminal by communicating with a backstage system, wherein the credit loading limit of the terminal is a sum of capital that allows for offline credit loading;
(B) an electronic card performs update of the account of electronic cash card by communicating with the terminal, wherein some capital of the credit loading limit of the terminal is transferred to the account of electronic cash card; and
(C) the backstage system enables the credit loading account associated with the account of electronic cash card to be updated according to information on offline credit loading received from the terminal.

2. The method according to claim 1, characterized in that, at step (A),
the terminal sends an update request of credit loading limit of the terminal to the backstage system, the request comprises ID of a safety module provided in the terminal, wherein the safety module is used for storing the credit loading limit of the terminal,
the backstage system generates an update command of the credit loading limit of the terminal according to the update request of credit loading limit of the terminal,
the terminal receives the update command of the credit loading limit of the terminal, and updates the credit loading limit of the terminal stored in the safety module according to the update command of the credit loading limit of the terminal.

3. The method according to claim 2, characterized in that, at step (B),
(a) the electronic cash card sends a request of offline credit loading to the terminal;
(b) the terminal verifies the electronic cash card according to the request of offline credit loading;
(c) the terminal returns a confirmation response to the offline credit loading to the electronic cash card;
(d) the electronic cash card verifies the terminal according to the confirmation response to the offline credit loading;
(e) the terminal sends a command of offline credit loading to the electronic cash card;
(f) the electronic cash card updates the account of electronic cash card according to the command of offline credit loading.

4. The method according to claim 3, characterized in that, at step (a),
when the balance of the account of electronic cash card is lower than a predetermined value, the electronic cash card sends the request of offline credit loading to the terminal.

5. An offline credit loading system comprising an electronic cash card, a terminal and backstage system, characterized in that
the terminal is configured to perform update of credit loading limit of a terminal by communicating with the backstage system, the terminal credit loading limit is a sum of capital that allows for offline credit loading,
the electronic cash card is configured to perform update of the account of electronic cash card by communicating with the terminal, wherein some capital of the credit loading limit of the terminal is transferred to the account of electronic cash card, and
the backstage system is configured to enable the credit loading account associated with the account of electronic cash card to be updated according to information on offline credit loading received from the terminal.

6. The system according to claim 5, characterized in that,
the terminal is configured to send an update request of credit loading limit of the terminal to the backstage system, which request comprises ID of a safety module provided in the terminal, wherein the safety module is used for storing the credit loading limit of the terminal,
the backstage system is configured to generate an update command of the credit loading limit of the terminal according to the update request of credit loading limit of the terminal,
the terminal is configured to receive the update command of credit loading limit of the terminal and update the credit loading limit of the terminal stored in the safety module according to the update command of the credit loading limit of the terminal.

7. The system according to claim 6, characterized in that,
the electronic cash card is configured to send a request of offline credit loading to the terminal,
the terminal is configured to verify the electronic cash card according to the request of offline credit loading,
the terminal is configured to return a confirmation response to the offline credit loading to the electronic cash card,
the electronic cash card is configured to verify the terminal according to the confirmation response to the offline credit loading,
the terminal is configured to send a command of offline credit loading to the electronic cash card, and
the electronic cash card is configured to update the account of electronic cash card according to the command of offline credit loading.

8. The system according to claim 6, characterized in that,
the electronic cash card is configured such that when the balance of the account of electronic cash card is lower than a predetermined value, the electronic cash card sends the request of offline credit loading to the terminal.

9. The system according to claim 8, characterized in that,
the backstage system stores a master key for limit update,
the safety module stores a sub key for limit update,
wherein the backstage system calculates the sub key for limit update using the master key for limit update and based on the ID of the safety module, and encrypts the update command of the credit loading limit of the terminal using the calculated the sub key for limit update, and
the terminal decrypts the update command of the credit loading limit of the terminal using the sub key for limit update.

10. The system according to claim 9, characterized in that,
the safety module also stores a master key for offline credit loading,
the electronic cash card stores a sub key for offline credit loading,
wherein the request of offline credit loading comprises a first authentication code of offline credit loading which is generated by the electronic cash card based on the sub key for offline credit loading and a first category of transaction data, and
the safety module is further configured to calculate the sub key for offline credit loading according to the ID of the electronic cash card and the master key for offline credit loading, and to use the calculated sub key for offline credit loading and the first category of transaction data to generate a second authentication code of offline credit loading; and
when the second authentication code of offline credit loading is the same as the first authentication code of offline credit loading, the safety module determines that the electronic cash card has passed the authentication.

11. The system according to claim 10, characterized in that,
the confirmation response to the offline credit loading comprises a first confirmation code of offline credit loading which is generated by the safety module based on the calculated sub key for offline credit loading and a second category of transaction data, and
the electronic cash card is further configured to calculate a second confirmation code of offline credit loading based on the sub key for offline credit loading and the second category of transaction data; and when the second confirmation code of offline credit loading is the same as the first confirmation code of offline credit loading, the electronic cash card determines that the terminal has passed the authentication.

12. An electronic cash card, characterized in that
the electronic cash card is configured to be able to send a request of offline credit loading to a terminal, to verify the terminal according to a confirmation response to the offline credit loading returned from the terminal, to receive a command of offline credit loading from the terminal, and to update the account of the electronic cash card according to the command of offline credit loading.

13. The electronic cash card according to claim 12, characterized in that,
the electronic cash card stores a minimum predetermined value of balance, and the electronic cash card is configured such that when the balance of the account of electronic cash card is lower than the minimum predetermined value of balance, the electronic cash card sends the request of offline credit loading to the terminal.

14. An offline credit loading terminal, characterized in that,
the terminal comprises a safety module used for storing credit loading limit of the terminal, the terminal is configured to be able to send an update request of credit loading limit of the terminal to a backstage system, the update request of credit loading limit of the terminal comprises ID of the safety module,
the terminal is further configured to receive an update command of the credit loading limit of the terminal, and to update the credit loading limit of the terminal stored in the safety module according to the update command of the credit loading limit of the terminal.

15. The terminal according to claim 14, characterized in that,
the terminal is further configured to be able to receive a request of offline credit loading from the electronic cash card, to verify the electronic cash card according to the request of offline credit loading, and to send a command of offline credit loading to the electronic cash card, which command is used for updating the account of the electronic cash card.
